(19) United States
(12) Patent Application Publication
(10) Pub. No.: US 2010/0011915 A1
(43) Pub. Date: Jan. 21, 2010

(54) SPHERICAL RATCHET WRENCH

(76) Inventor: David Badger, Plano, TX (US)

Correspondence Address: Michael L. Diaz;Diaz and Associates, Suite 200, 555 Republic Drive, Plano, TX, 75074, US

(21) Appl. No.: 12/174,942

(22) Filed: Jul. 17, 2008

(51) Int. Cl. B25B 13/46; B25B 13/06

(52) U.S. Cl. 81/60; 81/124.4

(57) ABSTRACT

A spherical ratchet wrench for use on fasteners. The ratchet wrench includes a sphere, a plurality of extensions extending out from a surface of the sphere, and a socket receiving mechanism attached to the sphere. The socket receiving mechanism is adapted for receiving and holding a socket. The ratchet wrench also includes a ratchet mechanism coupled to the socket receiving mechanism for turning a fastener. A socket is positioned within the socket receiving mechanism and the sphere is grasped by a user's hand for turning the ratchet wrench and the ratchet mechanism. Preferably, the extensions are removable sockets, providing a storage area for sockets.

### BACKGROUND OF THE INVENTION

1. Field of the Invention:

This invention relates to tools. Specifically, and not by way of limitation, the present invention relates to a spherical ratchet wrench.

2. Description of the Related Art:

There are many types of ratchet wrenches. Conventional ratchet wrenches usually include a wrench main body, a gear having gear teeth adapted to receive a torque, a switch mechanism and a gear engaging member, such as a pawl having engaging teeth for intermeshing with the teeth on the gear. Typically, the switch mechanism is selectively moveable between two positions. In each of these two positions, the pawl is engaged with the gear teeth such that the wrench in one direction rotates the gear to apply torque to a fastener and rotating the wrench in the opposite direction causes the pawl to ride over the gear teeth in a ratcheting manner.

To provide adequate torque to the wrench main body, the wrench main body is typically elongated. Obviously, the longer the wrench main body, the greater torque the user is able to apply. However, the wrench is oftentimes cumbersome to handle, especially in small places. A ratchet wrench is needed which allows the user to easily apply torque to the fastener.

It is well known in the sport of baseball, that a user's grip on the baseball provides extraordinary torque. In particular, a pitcher's grip of the baseball when throwing a “fastball” utilizes a unique finger placement while enabling the pitcher to exert considerable force to the ball. A wrench is needed which enables a user to grip the wrench in a similar manner as a baseball.

Typically, ratchet wrenches utilize removable sockets. The sockets are sized to fit various sizes of fittings and fasteners, such as nuts and bolts. However, because of the wide variety of sizes of fittings and fasteners, a large number of sockets is needed. However, because of the large number of sockets, it is often difficult to find a convenient storage area for the sockets. An apparatus is needed which would allow for the storage of a plurality of sockets.

It would be advantageous to have a wrench which enables the gripping of the wrench in a similar manner as a player holds a baseball. In addition, it would be advantageous to have a ratchet wrench which provides for the storage of the sockets on the wrench. Furthermore, it would be advantageous to have a ratchet wrench which enables the user to apply considerable torque to the wrench with ease. It is an object of the present invention to provide such an apparatus.

### SUMMARY OF THE INVENTION

In one aspect, the present invention is directed to a ratchet wrench. The ratchet wrench includes a sphere, a plurality of extensions extending out from a surface of the sphere, and a socket receiving mechanism attached to the sphere. The socket receiving mechanism is adapted for receiving and holding a socket. The ratchet wrench also includes a ratchet mechanism coupled to the socket receiving mechanism for turning a fastener. A socket is positioned within the socket receiving mechanism and the sphere is grasped by a user's hand for turning the ratchet wrench and the ratchet mechanism.

In one embodiment, the extensions are sockets, each socket sized to fit a different sized fastener.

In another embodiment, the ratchet wrench includes a removable socket driver having an elongated member to provide an additional handhold for the user.

In another embodiment, the extensions are spaced on the surface of the sphere to enable a user's hand to completely contact the surface of the sphere.

In still another embodiment, the extensions are spaced to enable the user's index finger to be positioned on a first side of the socket receiving mechanism and the user's middle finger to be position on a second opposing side of the socket receiving mechanism.

In another embodiment, the ratchet wrench includes a switch for selecting a direction of the ratchet mechanism.

In another embodiment, the ratchet wrench may be powered by a motor.

### BRIEF DESCRIPTION OF THE DRAWINGS

FIG. 1 is a right side perspective view of a spherical ratchet wrench in the preferred embodiment of the present invention;

FIG. 2 is a front perspective view of the spherical ratchet wrench of FIG. 1;

FIG. 3 is a left side view of the spherical ratchet wrench of FIG. 1;

FIG. 4 is a side perspective view of the spherical ratchet wrench gripped by a user's hand; and

FIG. 5 is a side view of the spherical ratchet wrench having an elongated socket driver.

### DESCRIPTION OF THE INVENTION

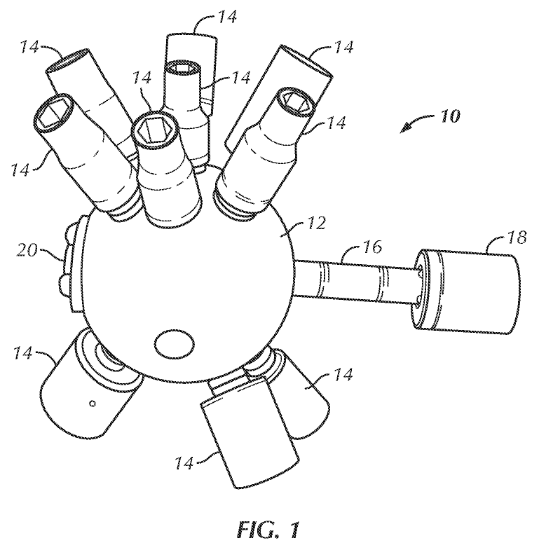

The present invention relates to a spherical ratchet wrench capable of storing a plurality of sockets. FIG. 1 is a right side perspective view of a spherical ratchet wrench 10 in the preferred embodiment of the present invention. The spherical ratchet wrench 10 includes a sphere 12. The sphere may be constructed of any rigid material, such as steel, stainless steel, composite material, etc. In the preferred embodiment of the present invention, the sphere has an approximate diameter of two inches. However, the sphere may be any size which enables a user to comfortably grip the sphere. The sphere includes a plurality of extensions or sockets 14. In the preferred embodiment of the present invention, the extensions are detachable sockets of various sizes. In an alternate embodiment of the present invention, the extensions may be any raised material rising from the surface of the sphere 12. In another alternate embodiment, the sphere has no extensions.

The spherical ratchet wrench 10 includes an elongated member 16 having a socket receiving mechanism 18. Preferably, on an opposing side of the sphere from the elongated member 16 is a switch mechanism 20. Within an interior portion of the sphere, the ratchet wrench preferably includes components typically found in a ratchet wrench, such as a gear having gear teeth adapted to receive a torque and a gear engaging member, such as a pawl having engaging teeth for intermeshing with the teeth on the gear. Although not shown in any of the figures, the various components of a ratchet wrench are well known in the art and are preferably utilized in the present invention.

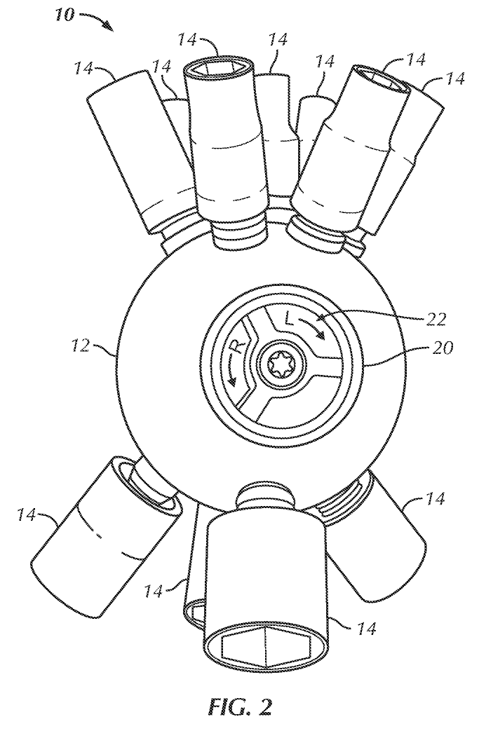

FIG. 2 is a front perspective view of the spherical ratchet wrench 10 of FIG. 1. The spherical ratchet wrench 10 includes the switch mechanism 20 having a selector 22 proving a selectively moveable switch between two positions. In each of these two positions, a pawl is engaged with the gear teeth such that the wrench in one direction rotates the gear to apply torque to a fastener and rotating the wrench in the opposite direction causes the pawl to ride over the gear teeth in a ratcheting manner (not shown). The selector allows the tightening and loosening of a fastener in a first position and a loosening and tightening of the fastener in the second position. Preferably, the switch mechanism is located on an opposite side of the sphere 12. However, in other embodiments, the selector may be located anywhere on the sphere.

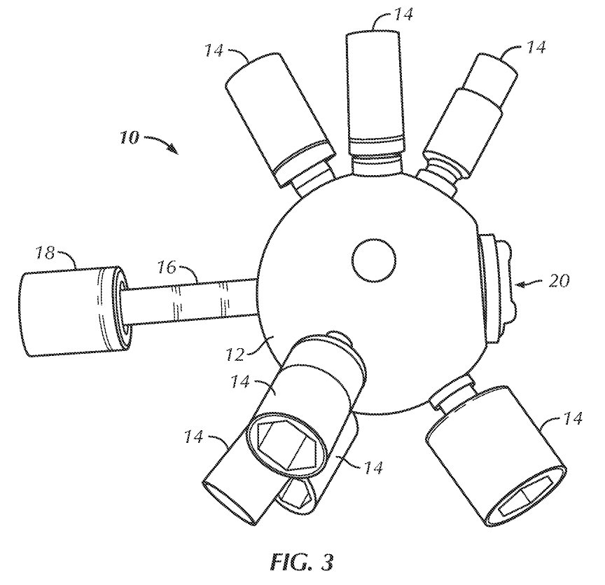

FIG. 3 is a left side view of the spherical ratchet wrench 10 of FIG. 1. The sockets are located in various locations on the sphere 12. The sockets are preferably removable from the sphere. The sockets may be held in place on the sphere by contoured outcroppings adapted for receiving the socket's head (not shown) in a similar manner that sockets are held in place on a conventional ratchet wrench. However, the sockets may be attached in any manner to the sphere and still remain in the scope of the invention. A socket may be removed from the sphere and attached to the socket receiving mechanism 18 in a similar manner as sockets are attached to existing ratchet wrenches. In an alternate embodiment of the present invention, the sockets may be any type of extension. The extension from the sphere enables a user to firmly grip and turn the sphere.

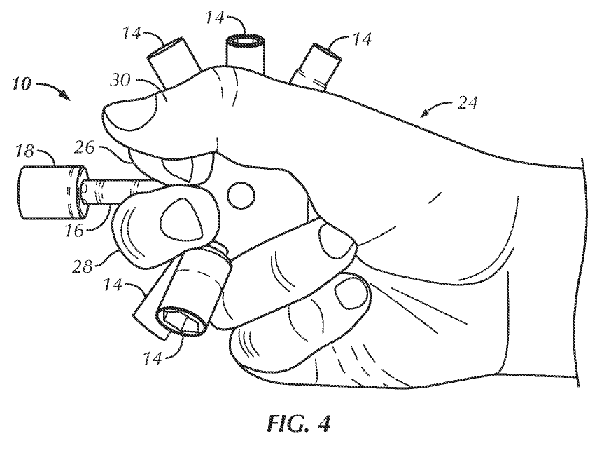

FIG. 4 is a side perspective view of the spherical ratchet wrench 10 gripped by a user's hand 24. The sockets (extensions) 14, affixed to the sphere 12 are preferably spaced to enable a user to grasp the sphere and wrapped an index finger 26, a middle finger 28, and a thumb 30 around the sphere. As depicted in FIG. 4, the user grasps the sphere in a similar fashion that a baseball pitcher grasps a baseball when throwing a “fastball”. In the preferred embodiment of the present invention, the sockets are spaced to allow the alignment of the fingers upon the sphere's surface as depicted in FIG. 4. In addition, in the preferred embodiment of the present invention, the sockets are positioned in a symmetrical fashion (i.e., one side of the sphere includes sockets spaced in an identical configuration as the opposite side) to enable a user to grasp the sphere with either the left or right hand.

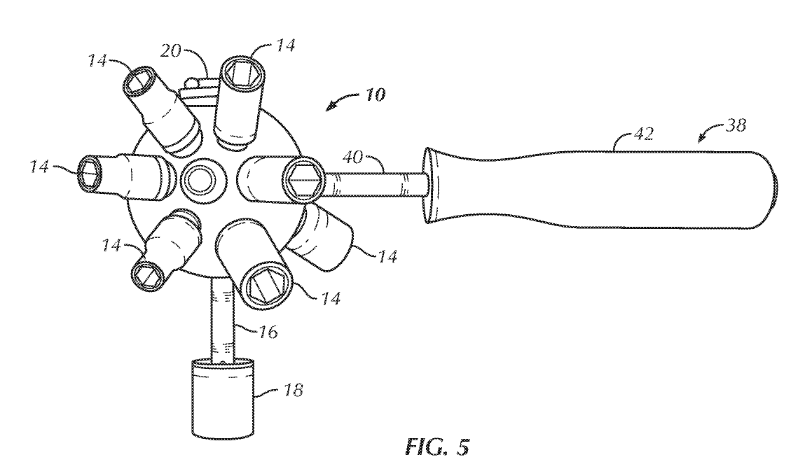

FIG. 5 is a side view of the spherical ratchet wrench 10 having an elongated socket driver 38. The socket driver may be affixed upon the sphere 12 to allow the user to grasp the socket driver with one hand, while grasping the sphere with the other, thereby providing additional torque when turning the spherical ratchet wrench 10. The socket driver preferably includes an elongated main section 40 and a handle 42. The sphere may include an indentation, protuberance, bore, or other receiving mechanism to allow the socket driver to be securely coupled to the sphere. In addition, the receiving mechanism (e.g., bore or indentation) is preferred located on both sides of the sphere to allow a user to grasp the socket driver with either the left or right hand. As depicted in FIG. 5, the spherical ratchet wrench has a distinct “pistol”-like configuration with the longest extensions being the barrel and the handle. In this configuration, the spherical ratchet wrench may be easily carried in a holster worn by the user.

With reference to FIGS. 1-5, the operation of the spherical ratchet wrench 10 will now be explained. The spherical ratchet wrench 10 preferably includes a plurality of sockets 14 for use on a wide variety of fasteners. The removable sockets are attached to the sphere by outcroppings for accommodating the head of the sockets (not shown). The user selects the socket by removing the socket from the sphere and inserting the head of the socket into the socket receiving mechanism 18. The selected socket 14 is attached to the socket receiving mechanism 18 in a similar fashion as sockets are affixed to a convention ratchet wrench. The user selects the direction the ratchet wrench turns to tighten and loosen the fastener by positioning the selector 22 to the desired direction. The user then grasps the sphere, preferably as shown in FIG. 4, where the middle finger 28 rests on one side of the elongated member 16 while the index finger 26 is positioned on an opposite side of the elongated member. Next, the user positions the socket upon the fastener and turns the spherical ratchet wrench 10 in the direction desired to loosen or tighten the fastener. To provide additional torque, the user may attach the optional socket driver 38 to the sphere whereby the user grasps the socket driver with the other hand and turns the sphere. The socket driver may perform the dual role of providing a hand tool for turning a fastener (when removed from the sphere). The user may switch the desired direction by positioning the selector 22 to the other position. Furthermore, the user may select another socket 14 as desired for the fastener.

In an alternate embodiment of the present invention, the spherical ratchet wrench 10 may be motorized. For example, a motor may be housed within the interior of the sphere to provide the turning force on the socket receiving mechanism 18. The motor may be powered by a rechargeable battery or coupled to an air source for driving the motor. Alternatively, the motor may be connected to a power outlet by a power cord. In addition, the present invention may be embodiment in other types of tools, such as screw drivers, wrenches, etc., where the handle is spherical and includes a plurality of extensions to provide an easy handhold for the user. In addition, the sphere may be utilized for other tools that are not fastening tools. For example, a hammer head may be attached to the sphere. The user may then grasp the sphere and strike a nail with the hammer head. In other examples, the sphere may include a hack saw or wood saw. In an alternate embodiment of the present invention, the sphere may be used as a grip for a wide variety of tools or utensils which requires the grip of a user. For example, a sphere may be used for a knife or a brush. In another alternate embodiment, the sphere may be used for a person having limited hand strength and dexterity. In this embodiment, the sphere may include a grappling or vise-like mechanism for grasping objects which the user does not have the strength to hold without help.

The present invention provides distinct advantages over existing ratchet wrenches. The present invention enables the storage of a plurality of sockets upon the tool, thereby preventing the loss or misplacement of a socket. Furthermore, the present invention provides a handhold upon the ratchet wrench which enables the user to easily turn the spherical ratchet wrench 10 with considerable torque. The use of extensions enables the user to apply addition torque on the wrench.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A ratchet wrench, the ratchet wrench comprising:
a sphere;
a plurality of extensions extending out from a surface of the sphere; and
a socket receiving mechanism attached to the sphere, the socket receiving mechanism having means for receiving and holding a socket;
a ratchet mechanism coupled to the socket receiving mechanism for turning a fastener;
whereby a socket is positioned within the socket receiving mechanism and the sphere is grasped by a user's hand for turning the ratchet wrench and the ratchet mechanism.

2. The ratchet wrench according to claim 1 wherein the plurality of extensions are sockets.

3. The ratchet wrench according to claim 2 wherein the sockets are removable from the sphere and useable within the socket receiving mechanism.

4. The ratchet wrench according to claim 2 wherein each socket is sized and shaped to accommodate a fastener of a different size.

5. The ratchet wrench according to claim 1 wherein the extensions are spaced on the surface of the sphere to enable a user's hand to completely contact the surface of the sphere.

6. The ratchet wrench according to claim 5 wherein the extensions are spaced to enable the user's index finger to be positioned on a first side of the socket receiving mechanism and the user's middle finger to be position on a second opposing side of the socket receiving mechanism.

7. The ratchet wrench according to claim 1 wherein the socket receiving mechanism is affixed to an elongated member attached to the surface of the sphere.

8. The ratchet wrench according to claim 1 wherein the sphere has an approximate diameter of two inches.

9. The ratchet wrench according to claim 1 wherein the sphere is constructed of stainless steel.

10. The ratchet wrench according to claim 1 further comprising a switch for selecting a direction of the ratchet mechanism.

11. The ratchet wrench according to claim 1 further comprising an elongated socket driver attachable to the sphere to provide an additional handhold for the user.

12. The ratchet wrench according to claim 1 wherein the ratchet mechanism is housed in the sphere.

13. The ratchet wrench according to claim 1 wherein the ratchet mechanism is driven by a motor.

14. The ratchet wrench according to claim 13 wherein the motor is powered by a rechargeable battery.

15. The ratchet wrench according to claim 13 wherein the motor is powered by an air source.

16. A spherical ratchet wrench, the ratchet wrench comprising:
a sphere;
a plurality of removable sockets extending out from a surface of the sphere; and
a socket receiving mechanism coupled to a ratchet mechanism, the socket receiving mechanism having means for receiving and holding a socket;
wherein the socket receiving mechanism is affixed to an elongated member attached to the sphere;
whereby a socket is positioned within the socket receiving mechanism and the sphere is grasped by a user's hand for turning the ratchet wrench and the ratchet mechanism.
